(19) United States
(12) Patent Application Publication
(10) Pub. No.: US 2003/0123255 A1
(43) Pub. Date: Jul. 3, 2003

(54) Lamp assembly with dual mode reflector

(76) Inventor: Randy Marchetti, Scottsdale, AZ (US)

Correspondence Address: Sullivan Law Group, Suite 120, 5060 North 40th Street, Phoenix, AZ, 85018, US

(21) Appl. No.: 10/040,268

(22) Filed: Oct. 30, 2001

(51) Int. Cl. F21V 7/00

(52) U.S. Cl. 362/296

(57) ABSTRACT

This lamp assembly includes a reflector with first reflective concave surface region for directing light emanating from a first focal point adjacent to but spaced apart from the first reflective concave surface region into a near field beam and an adjacent second reflective concave surface region for directing light emanating from a second focal point adjacent to but spaced apart from the second reflective concave surface region into a far field beam. Preferably, the reflector is a unitary piece, and preferably has a substantially circular perimeter. The lamp assembly includes a high intensity discharge light source positioned substantially at the first focal point and a second halogen light source positioned substantially at the second focal point.

### BACKGROUND OF THE INVENTION

1. Field of the Invention

The present invention relates generally to lamp assemblies and related reflectors useful with vehicles, such as trucks, automobiles, motorcycles and the like, and, more specifically, to such lamp assemblies and related reflectors capable of providing relatively near field illumination as well as more distant field illumination.

2. Description of the Related Art

Lamp assemblies have been routinely used on vehicles for years. Vehicle headlamps are examples. In some applications, for example, on motorcyles, only a single headlamp may be provided. In other applications, for example, on automobiles, a pair of symmetrically disposed headlamps may be provided. In still other applications, for example, on some automobiles, trucks, recreational vehicles, boats, etc., the vehicle may have more than two headlights.

It also has been commonplace for such lamp assemblies to have a relatively near field illumination, e.g., providing a low beam, and a relatively more distant field illumination, e.g., providing a high beam. The low beam typically is adapted for use in areas and situations in which a high beam would cause glare and interference or disruption to people in the beam path. This can be especially troublesome and potentially dangerous where the beam would tend to blind oncoming vehicle operators. The low beam device typically directs the beam downwardly, and has a narrower beam width and a lower intensity to illuminate in the near field without unduly disrupting others. The high beam is adapted for use when the objective is to provide the greatest illumination intensity, and interference with or disruption of others in or around the beam path is not of great concern. High beams typically are for use in areas and situations where there are no oncoming vehicles, where the natural or alternatively lighting is not very bright, and where maximum illumination from the light assembly is required.

The designs and approaches used to achieve this dual mode, e.g., low and high beam, capability have changed over time. One known approach used to achieve this dual mode capability has involved the use of a light assembly wherein the intensity of the electrical energy provided to the assembly is changed, e.g., by a high and low beam switch. When low beams are desired, a lower level of energy is provided to the assembly. When the high beams are desired, the higher level of energy is provided, thus increasing the luminous intensity of the resulting beam.

Another approach to achieving dual mode vehicle light assemblies that has proven especially popular in automobiles involves the use of a headlamp assembly having two separate deflectors, each equipped with its own bulb. In the past, halogen bulbs have been used as the bulbs for both deflectors. In recent years, new light sources have emerged as candidates for use as low-beam bulbs in vehicle lamp assemblies. One such low-beam light source involves what have come to be referred to as high intensity discharge (“HID”) lights. HID lamps provide light by producing an arc, typically between an anode and a cathode, rather than energizing a filament. HID lamps typically employing a noble gas or a mixture of noble gases, such as xenon, krypton, and/or argon. Other gases that are often present in a HID lamp include mercury vapor and a variety of metal halide vapors that are blended to obtain greater output and improved spectral content in the light produced by the lamp. Application of a voltage to the HID light causes the interior gas to ionize to a sufficient level to cause the gas to emit light. The result is a brilliant illumination, which can be turned off by removal of the voltage. HID lights typically offer greater intensity than halogen lights at a given energy level. Thus, HID lights generally draw fewer amps than a halogen light operating at the same luminous output. The efficient use of energy by HID lights draws less energy from the engine, battery, alternator, etc., making HID lights attractive for use as low-beam lights for vehicles.

The use of separate reflectors, separate electronic sources, etc., has been disadvantageous, however, in a number of respects. These assemblies can consume more space than a single reflector, for example, and the duplication of parts can add extra weight and extra cost, e.g., associated with installing, removing, repairing, etc., multiple lighting assemblies. This can be particularly problematic for such vehicles as motorcycles, snowmobiles, and the like, where the space at the appropriate position or face of the vehicle may be quite limited. Where the lights comprise headlights, for example, the front of these vehicles where the headlight or headlights ideally would be positioned may be relatively small. Moreover, reflector size can significantly influence beam shape and beam intensity, which can strongly influence the ability of the light to illuminate the desired area. Decreasing reflector size to address size constraints often requires sacrifice to the effectiveness of the lighting device.

Yet another approach to achieving dual mode vehicle light assemblies has involved the use of two bulbs in the same deflector. The deflector has a concave, usually parabolic surface region on which the bulbs are mounted. The bulbs usually are spaced apart from one another. Switching between low beam and high beam is accomplished by actuating either one bulb or two bulbs simultaneously. That is, selection of the low beam causes illumination of one of the bulbs and results in a lower intensity, narrow beam, whereas selection of the high beam causes illumination both of the bulbs and results in a higher intensity, more diffuse or broader beam.

The use of this latter single-reflector approach has been especially popular in vehicles such as motorcycles and snowmobiles, which have limited space on the face of the vehicle for carrying a single front headlight. Such known single-reflector light assemblies have involved the use of halogen bulbs for both the low intensity and high intensity beam.

### OBJECTS OF THE INVENTION

Accordingly, an object of the present invention is to provide a lamp assembly and related reflector that provide advantages of high intensity discharge lighting, but wherein space occupied by the lighting device can be reduced relative to separate near and more distant field lighting devices.

Another object of the present invention is to provide a lamp assembly and related reflector that can be installed, repaired, replaced and/or maintained more readily than separate near and more distant field lighting devices.

Still another object of the present invention is to provide a single reflector lamp assembly that makes efficient use of high intensity discharge lighting, but does not present significant drawbacks of glare and wide beam spread.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve foregoing objects, and in accordance with the purposes of the invention as embodied and broadly described in this document, a lamp assembly is provided in accordance with a first aspect of the present invention. The lamp assembly of the first aspect of the invention comprises a reflector and a light-transmissive cover fitted over the reflector. The reflector comprises first and second reflective concave surface regions adjacent to one another. The first reflective concave surface region comprises a first curvature for directing light emanating from a first focal point adjacent to but spaced apart from the first reflective concave surface region into a near field beam. The second reflective concave surface region comprises a second curvature, which is preferably different from the first curvature, for directing light emanating from a second focal point adjacent to but spaced apart from the second reflective concave surface region into a far field beam. The lamp assembly further comprises a first light source positioned substantially at the first focal point, the first light source comprising a high intensity discharge (HID) light source, such as a xenon light source. The lamp assembly still further comprises a second light source positioned substantially at the second focal point, the second light source comprising a halogen light source.

The reflector may be substantially rounded, and is preferably substantially circular. The reflector has an outer periphery, which may terminate at a lip. In the preferred embodiment, the lip is also circular. The lip may be constructed and arranged as a mounting flange for mounting the light-transmissive cover thereon.

Preferably, the lip and the first and second reflective concave surface regions are integral or monolithic with one another. Still more preferably, the entire reflector is made of a unitary piece.

The first reflective concave surface region may be parabolic and have a first optical axis passing through the first focal point. Additionally or in the alternative, the second reflective concave surface region may be parabolic and have a second optical axis passing through the second focal point.

Optionally, the reflector may further comprise a partition or internal wall extending substantially perpendicular to the first and second reflective concave surface regions and situated at an interface of the first and second reflective concave surface regions. The internal wall may be substantially linear, and may optionally include an arcuate or crescent-shaped region equidistant from both of its ends.

In accordance with a second aspect of the invention, the lamp assembly comprises a reflector, first and second light sources, and a light-transmissive cover fitted over the reflector. The reflector comprises first and second reflective concave surface regions adjacent to one another. The first reflective concave surface region comprises a first curvature for directing light emanating from a first focal point adjacent to but spaced apart from the first reflective concave surface region into a near field beam. The first reflective concave surface region has a first peripheral edge with opposite ends and a first internal edge extending between the opposite ends of the first peripheral edge. The second reflective concave surface region comprises a second curvature for directing light emanating from a second focal point adjacent to but spaced apart from the second reflective concave surface region into a far field beam. The second reflective concave surface region has a second peripheral edge with opposite ends and a second internal edge extending between the opposite ends of the second peripheral edge. The respective opposite ends of the first and second peripheral edges interface one another and the first and second internal edges interface one another. The first light source is positioned substantially at the first focal point and comprises a high intensity discharge (HID) light source, such as, e.g., a xenon gas light source. The second light source is positioned substantially at the second focal point and comprises a halogen light source.

The first and second peripheral edges of the concave surface regions may be arcuate, and still further may together define a substantially circular outer perimeter of the reflector. The first and second reflective concave surface regions may terminate at a lip, which is also preferably substantially circular. The lip may function as a mounting flange for mounting the light-transmissive cover thereon.

Preferably, the first and second reflective concave surface regions are integral with one another, and more preferably integral with the lip as well. Still more preferably, the entire reflector is a unitary piece. In one variation of this embodiment, portions of the first and second peripheral edges of the reflective concave surface regions extend farther forward than the lip.

The first reflective concave surface region of this second aspect of the invention may be parabolic and have a first optical axis passing through the first focal point. In addition or in the alternative, the second reflective concave surface region may be parabolic and have a second optical axis passing through the second focal point.

The first and second internal edges may interface and adjoin one another over portions of their length to define a ridge. Optionally, the reflector may further comprise a partition or internal wall extending substantially perpendicular to the first and second reflective concave surface regions and situated at the ridge. The internal wall may be substantially planar and linear, and may optionally include an arcuate or crescent-shaped region spaced equidistant from both of the ends of the internal wall.

In accordance with a third aspect of this invention, a reflector suitable for use in a lamp assembly, such as a vehicular headlamp assembly, is provided. The reflector of this aspect of the invention comprises a first reflective concave surface region and a second reflective concave surface region adjacent thereto. The first reflective concave surface region comprises a first curvature for directing light emanating from a first focal point adjacent to but spaced apart from the first reflective concave surface region into a near field beam. The first reflective concave surface region has a first arcuate peripheral edge with opposite ends and a first internal edge extending between the opposite ends of the first arcuate peripheral edge. The second reflective concave surface region comprises a second curvature for directing light emanating from a second focal point adjacent to but spaced apart from the second reflective concave surface region into a far field beam. The second reflective concave surface region has a second arcuate peripheral edge with opposite ends and a second internal edge extending between the opposite ends of the second arcuate peripheral edge. The respective opposite ends of the first and second peripheral edges interface one another to define a substantially circular outer perimeter of the reflector and the first and second internal edges interface one another.

The first and second peripheral edges of the concave surface regions of the reflector may be arcuate, and still further may together define a substantially circular outer perimeter of the reflector. The first and second reflective concave surface regions may terminate at a lip, which is preferably substantially circular. The light-transmissive cover may be mountable on the optional lip. Preferably, the first and second reflective concave surface regions are integral with one another, and more preferably integral with the lip as well. Still more preferably, the entire reflector of this third aspect of the invention is a unitary piece. In one variation of this embodiment of the invention, the first and second peripheral edges of the reflective concave surface regions extend farther forward than the lip.

The first reflective concave surface region of the reflector of the third aspect of the invention may be parabolic and have a first optical axis passing through the first focal point. In addition or in the alternative, the second reflective concave surface region may be parabolic and have a second optical axis passing through the second focal point.

The first and second internal edges may interface and adjoin one another to define a ridge. Optionally, the reflector may further comprise a partition or internal wall extending substantially perpendicular to the first and second reflective concave surface regions and situated at the ridge. The internal wall may be substantially planar and linear, and may optionally include an arcuate or crescent-shaped region equidistant from both of the ends of the internal wall.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In such drawings:

FIG. 1 is a perspective front view of a reflector of a lamp assembly in accordance with a presently preferred but merely illustrative embodiment of the present invention;

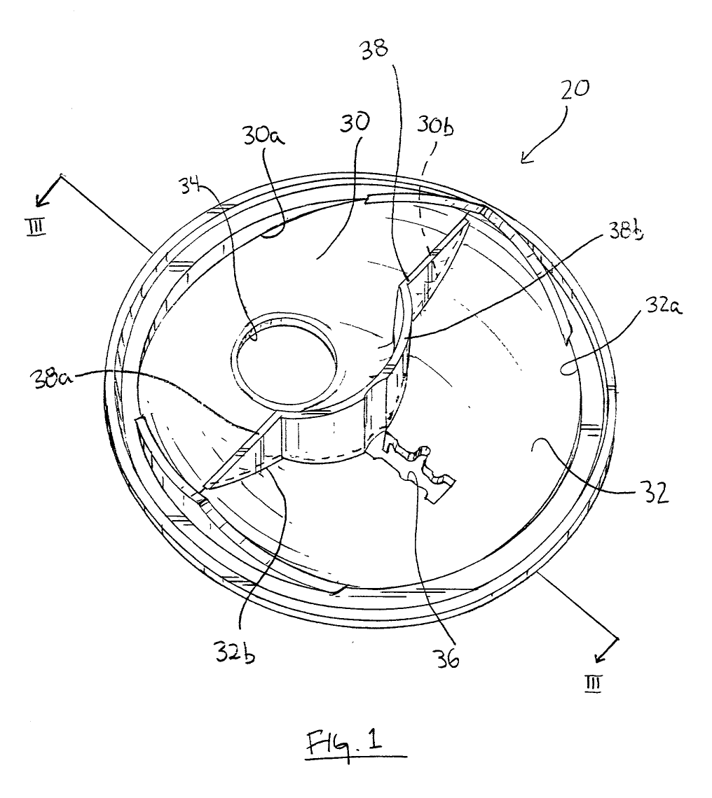

FIG. 2 is a front plan view of the reflector of FIG. 1;

FIG. 3 is a side view of a lamp assembly depicting the reflector of FIG. 1 and a light transmissive cover taken along sectional line III-III of FIG. 1 and first and second light sources in side elevation view; and

FIG. 4 is a perspective rear view of the reflector of FIG. 1.

### DETAILED DESCRIPTION OF PREFERRED EMBODIMENTS AND PREFERRED METHODS OF THE INVENTION

Reference will now be made in detail to the presently preferred embodiments and methods of the invention as described below. It should be noted, however, that the invention in its broader aspects is not limited to the specific details, representative devices and methods, and examples described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

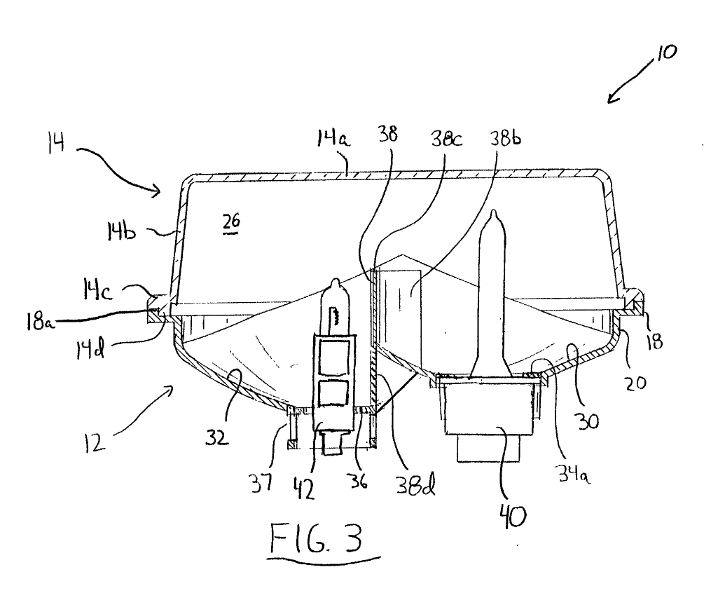

Referring now more particularly to the figures, and especially FIG. 3, a lamp assembly in accordance with a preferred embodiment of this invention is designated by reference numeral 10. The lamp assembly 10 includes a housing fixture 12 and a light-transmissive cover 14. The housing fixture 12 and the light-transmissive cover 14 may be mated together in any known manner. Suitable means for mating the housing fixture 12 and the light-transmissive cover 14 include, for example, screws, bolts, adhesive, clips, tabs, flanges, and the like, and combinations thereof. In the illustrated embodiment, the mating means comprises an adhesive.

The light-transmissive cover 14 includes a substantially disc-shaped front face portion 14a, a substantially cylindrical side wall 14b integral with and extending rearward from the front face portion 14a, and an annular flange portion 14c integral with and extending outward from the side wall 14b. The annular flange portion 14c has a rearward protruding annulus 14d. The light-transmissive cover 14 may be made of a transparent material, such as one selected from the group consisting of glass and plastic, such as polycarbonates. The cover may, however, be colored, frosted, semi-transparent or translucent, and the like. The front face portion 14a of the light-transmissive cover 14 may include prisms, facets, or other designs or patterns. The light-transmissive cover 14 may be optically clear, tainted, or colored for providing the desired illumination effect. Lens means may be incorporated or embodied in the cover 14, especially the front face portion 14a, to direct, condition, or otherwise affect the beam passing through it.

In the illustrated embodiment, the housing fixture 12 comprises a reflector 20 having a surrounding mounting flange 18. In the preferred and illustrated embodiments, the mounting flange 18 and the reflector 20 are integral, meaning that they form a unitary piece. As illustrated, the mounting flange 18 forms an integral lip of the reflector 20. The mounting flange 18 is mated to the light-transmissive cover 14 via mating means. For example, in the illustrated embodiment the mounting flange 18 is provided with an annular outer rim 18a for receiving annulus 14d and an adhesive. Alternatively, the mounting flange 18 may have a plurality of openings spaced circumferentially from one another for receiving mating means, such as screws, bolts, clips, tabs, flanges, and the like, that attach to corresponding openings in the light transmissive cover 14. In its preferred and illustrated embodiments, the mounting flange 18 is annular with substantially circular outer and inner peripheries.

For convenience and brevity and for explanatory purposes, the terms “forward,” “rearward,” “inward,” and “outward” will be used herein to describe the relationships of various features of the preferred embodiment relative to each other, as shown in the drawing figures. As referred to herein and in the claims, forward and rearward are referenced along the longitudinal axis of the lamp assembly 10. Thus, the light-transmissive cover 14 is generally forward of the mounting flange 18, and the mounting flange 18 is generally rearward of the light-transmissive cover 14. As referred to herein, inward and outward are referenced along a radial direction of the lamp assembly 10, with inward meaning closer to the center of the assembly 10 and outward meaning closer to the periphery of the assembly 10. Thus, the reflector 20 is generally inward with respect the mounting flange 18, and the mounting flange 18 is generally outward relative to the reflector 20.

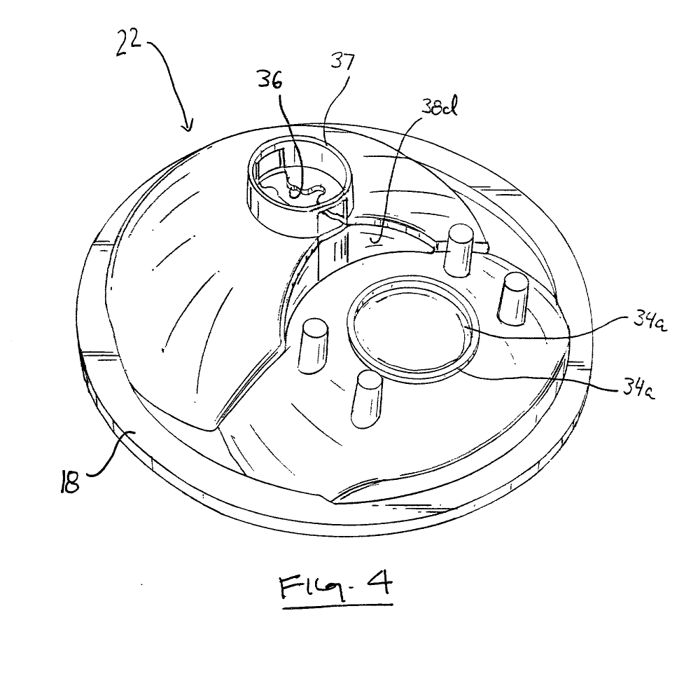

As shown in FIG. 4, the reflector 20 has a rear surface 22 facing away from the light-transmissive cover 14. Although not shown, the lamp assembly 10 may comprise a detachable back cover rearward of the reflector 20 for protecting the rear surface 22 and mounting the lamp assembly 10 to a vehicle. Alternatively, and as illustrated, the rear surface 22 may include a mounting means on the reflector 20. For example, in the illustrated embodiment a plurality of prongs (e.g., four) extends from the rear surface 22 for mounting the lamp assembly 10 to a vehicle.

The reflector 20 has a forward-facing surface opposing the light-transmissive cover 14. To provide the forward-facing surface with a reflective property, the forward-facing surface of the reflector 20 may be either formed of a reflective material, such as metallic material (e.g., aluminum), or have a reflective material, such as metallic material (e.g., aluminum), deposited or applied thereto. The forward-facing surface of the reflector 20 is spaced from the light-transmissive cover 14 to define a chamber 26 therebetween.

The forward-facing surface of the reflector 20 is divided into a first reflective concave surface region 30 and a second reflective concave surface region 32, which are adjacent to one another. The first and second concave surface regions 30 and 32 are preferably integral with each other. Still more preferably, the entire reflector 20 is a unitary piece.

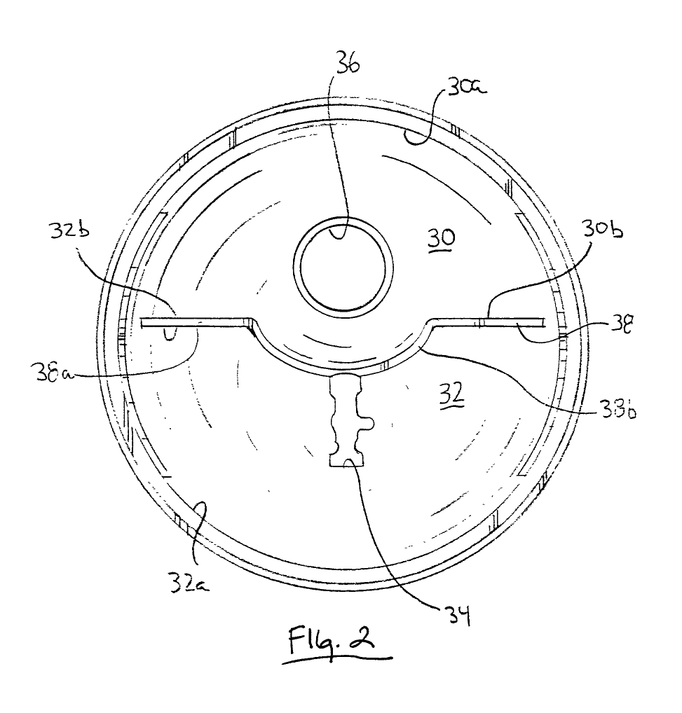

In the preferred and illustrated embodiments, the first reflective concave surface region 30 has a first arcuate peripheral edge 30a with opposite ends and a first internal edge 30b extending between the opposite ends of the first arcuate peripheral edge 30a. Likewise, the second reflective concave surface region 32 has a second arcuate peripheral edge 32a with opposite ends and a second internal edge 32b extending between the opposite ends of the second arcuate peripheral edge 32a. In this preferred embodiment, when viewed from above as in FIG. 2, the first and second arcuate peripheral edges 30a and 30b have their respective ends interfacing one another, and together define a circular outer perimeter of the reflector 20. Further, each of the first and second reflective concave surface regions 30 and 32 has a substantially semi-circular appearance, although the surface regions 30 and 32 are asymmetrical to each other. The arcuate peripheral edge 30a of the first reflective concave surface region 30 extends for slightly less than 180 degrees of the circular outer perimeter of the reflector 20. The arcuate peripheral edge 32a of the second reflective concave surface region 32 extends the remainder, or slightly more than 180 degrees, around the outer perimeter of the reflector 20. Thus, the interface of the internal edges 30b and 32b is slightly displaced relative to an imaginary diametrical line passing through the center of the reflector 20.

The first internal edge 30b has a symmetrical, substantially U-shaped appearance, with the central portion of the first internal edge 30b situated farther rearward than the opposite ends of the first internal edge 30b. Likewise, the second internal edge 32b has a symmetrical, substantially U-shaped appearance, with the central portion of the second internal edge 32b situated farther rearward than the opposite ends of the second internal edge 32b. The first and second internal edges 30b and 32b of the first and second reflective concave surface regions 30 and 32 interface one another over their respective lengths. Over an outer portion of their respective lengths, the first and second internal edges 30b and 32b have a common depth and intersect one another to form a discontinuous ridge. Over a central portion of their respective lengths, the first and second interfacing internal edges 30b and 32b are offset in depth from one another, with the second internal edge 32b extending farther rearward than the first internal edge 30b. In an optional embodiment, and as illustrated, a partition 38 is positioned at the interface of the first and second internal edges 30b and 32b. Symmetrical, substantially linear wall portions 38a are situated over the discontinuous ridge at which the outer portions of the internal edges 30b and 32b interface and intersect one another. The partition 38 further includes a symmetric crescent-shaped portion 38b interposed centrally between the symmetrical, substantially linear wall portions 38a. The crescent-shaped portion 38b extends between interfacing central portions of the internal edges 30b and 32b

The partition 38 is preferably opaque, more preferably reflective. In the illustrated embodiment the partition 38 is planar and extends forward substantially perpendicular to the first and second reflective concave surface regions 30 and 32 to terminate at a free edge 38c (FIG. 3) protruding forward of the mounting flange 18. The free edge 38c faces but is spaced apart from the front face portion 14a of the light transmissive cover 14. The partition 38 may be integrally formed, i.e., as a single piece, with the first and second reflective surface regions 30 and 32.

The first reflective concave surface region 30 comprises a first curvature for directing light emanating from a first focal point adjacent to but spaced apart from the first reflective concave surface region 30 into a near field beam. The first reflective concave surface region 30 includes an opening 34, which preferably lies along an optical axis passing through the first focal point. As best seen in FIGS. 3 and 4, the opening 34 has a rear seat 34a defined by a radial inward-extending rim. Preferably, the first reflective concave surface region 30 is parabolic. In the illustrated embodiment, the first reflective concave surface region 30 is completely rotary parabolic, meaning that the partition 38 does not obstruct the parabolic first reflective concave surface region 30 from extending around the opening 34 by 360 degrees. In particular, the presence of crescent-shaped portion 38b of the partition 38 establishes surface area for first reflective concave surface region 30 between the opening 34 and the internal edge 30b.

The second reflective concave surface region 32 comprises a second curvature for directing light emanating from a second focal point adjacent to but spaced from the second reflective concave surface region 32 into a far field beam. The second curvature need not necessarily be different from the first curvature. It is possible, for example, to have reflective concave surface regions or sections with the same curvature, but wherein the focal point of the light source is relatively displaced, or where the geometry of the beam from the light source to the reflector region or section is different, etc. The second reflective concave surface region 32 includes an opening 36, which preferably lies along an optical axis passing through the second focal point. As best seen in FIG. 4, to the rear of opening 36 is an annular boss 37. In the illustrated embodiment, the second reflective concave surface region 32 is parabolic or partially rotary parabolic. As illustrated, the partition 38, and more particularly crescent-shaped portion 38b of the partition 38, intersects the opening 36 to obstruct the parabolic second reflective concave surface region 32 from extending around the opening 36 by 360 degrees.

In the illustrated embodiment, a rearward-most portion of the first reflective concave surface region 30 surrounding the opening 34 is set forward relative to a rearward-most portion of the second reflective concave surface region 32 surrounding the opening 36. Thus, the second reflective concave surface region 32 has a greater depth dimension than the first reflective surface region 30. A step portion 38d of the partition 38 is coextensive with the crescent-shaped portion 38b of the partition and extends across depth differential between the interfacing, yet axially displaced, internal edges 30b and 32b of the reflective concave surface regions 30 and 32.

The partition 38 is offset from an imaginary diametric line of the reflector 20, so that the partition 38, if linear and planar across its entire length, would divide the first and second reflective concave surface regions 30 and 32 into unequal, asymmetrical surface areas. That is, the first reflective concave surface region 30 would have a lesser surface area than the second reflective concave surface region 32. In order partially negate this discrepancy in surface area, the crescent portion 38b protrudes toward the second reflective concave surface region 32. It is to be understood, however, that the partition 38 may be situated along a diameter of the reflector 20 and may exclude the crescent portion 38b.

A first light source 40 is positioned substantially at the first focal point, and comprises a high intensity discharge (HID) light source. In a particularly preferred embodiment of this invention, the HID light source comprises xenon gas. The first light source 40 is inserted through the opening 34 from the rear section 22 of the housing fixture 12 and rested against the seat 37, so that a light-emitting portion of the first light source 40 protrudes into the chamber 26. Conventional or novel means, such as adhesive, clips, screws, bolts, and the like, may be used for mounting the first light source 40 against the seat 37. The light-emitting portion of the first light source 40 situated substantially at the first focal point so that light emitted from the first light source 40 is reflected from the first reflective concave surface 30 and through the light-transmissive cover 14 as a near-field beam at a high yield.

The boss 37 receives the second light source 42, so that a light-emitting portion of the second light source 42 extends through the opening 36 from the rear section 22 of the housing fixture 12 into the chamber 26. The second light source 42 is mounted adjacent the second reflective concave surface region 32. Means for mounting the second light source 42 include known and novel techniques, such as adhesive, clips, screws, bolts, and the like. The light-emitting portion of the second light source 42 is situated substantially at the second focal point, so that light emitted from the second light source 42 is reflected from the second reflective concave surface 32 and through the light-transmissive cover 14 at a high yield as a far-field beam. The second light source 42 preferably comprises a halogen light source.

Conventional means may be used for attaching lead wires of the light sources 40 and 42 to a suitable power source, such as the engine, car battery or starter.

Although not shown, the light source 40 and/or the light source 42 may include a shade positioned between it and the light transmissive cover 14 for cutting direct light beams (i.e., light beams not reflected by the reflector 20) projected from the light source 40 and/or the light source 42 forward of the lamp assembly 10. The shade or shades may be mounted, for example, to the partition 38 to extend forward of the light source(s) 40 and/or 42. Shades are especially useful for the high intensity discharge (HID) light 40.

Operation of the lamp assembly 10 of this embodiment of the invention will now be explained in further detail.

The lamp assembly 10 is especially useful as a vehicular head lamp for cars, trucks, sports utility vehicles, motorcycles, snowmobiles, tractors, off-road vehicles, and the like. The reflector 10 is composed of low-beam and high-beam reflecting surfaces disposed closely adjacent to each other, making it possible to significantly reduce the mounting surface area needed for mounting the lamp assembly 10 on the front of the vehicle. Incorporation of a high intensity discharge (HID) light source for the low-beam enhances energy conservation, and the matching of a high-beam halogen light with the HID light source for high-beam operation improves the driver's view for nighttime driving without creating an unacceptable amount of glare, such as for oncoming drivers.

The lamp assembly 10 may be mounted on a vehicle in various orientations. It is preferred, however, for the first reflective concave surface region 30 to be vertically disposed with respect to the second reflective concave surface region 32. The first reflective concave surface region 30 may be positioned either below or above the second reflective concave surface region 32.

In operation, the light sources 40 and 42 are activated by the vehicle driver and/or by an automated system. Activation of the first light source 40 generates light rays, which are reflected by the first reflective concave surface 30 in a forward direction through the light-transmissive cover 14. The reflected rays form a near field beam for illuminating the area in front of the vehicle. It is within the scope of this invention to activate the far field beam by either illuminating the second light source 42 alone or illuminating both the first and second light sources 40 and 42 simultaneously. Activation of the second light source 42 generates light rays, which are reflected by the second reflective concave surface 32 in a forward direction through the light-transmissive cover 14. The reflected rays, either alone or in combination with rays generated by the first light source 40, form a far field beam for illuminating the area distant to the front of the vehicle.

The above headlight may be a movable unit type headlight in which the reflector is fixed to the light transmissive cover. Alternatively, the above headlight may be a movable reflector type headlight in which the reflector is accommodated in a space formed by the light transmissive cover and lamp body.

The foregoing detailed description of the preferred embodiments of the invention has been provided for the purposes of illustration and description, and is not intended to be exhaustive or to limit the invention to the precise embodiments disclosed. The embodiments were chosen and described in order to best explain the principles of the invention and its practical application, thereby enabling others skilled in the art to understand the invention for various embodiments and with various modifications as are suited to the particular use contemplated. It is intended that the scope of the invention cover various modifications and equivalents included within the spirit and scope of the appended claims.

What is claimed is:

1. A lamp assembly comprising:
a reflector comprising first and second reflective concave surface regions adjacent to one another, the first reflective concave surface region comprising a first curvature for directing light emanating from a first focal point adjacent to but spaced apart from the first reflective concave surface region into a near field beam, and the second reflective concave surface region comprising a second curvature for directing light emanating from a second focal point adjacent to but spaced apart from the second reflective concave surface region into a far field beam;
a first light source positioned substantially at the first focal point, the first light source comprising a high intensity discharge light source;
a second light source positioned substantially at the second focal point, the second light source comprising a halogen light source; and
a light-transmissive cover fitted over the reflector.

2. A lamp assembly as recited in claim 1, wherein the reflector is substantially rounded.

3. A lamp assembly as recited in claim 1, wherein the reflector is substantially circular.

4. A lamp assembly as recited in claim 1, wherein the first and second reflective concave surface regions are integral with one another.

5. A lamp assembly as recited in claim 1, wherein the reflector is a unitary piece.

6. A lamp assembly as recited in claim 1, wherein the first concave reflective surface region is parabolic and has a first optical axis passing through the first focal point, and further wherein the second concave reflective surface region is parabolic and has a second optical axis passing through the second focal point.

7. A lamp assembly as recited in claim 1, wherein the second curvature is different than the first curvature.

8. A lamp assembly as recited in claim 1, wherein the high intensity discharge light source comprises a xenon light source.

9. A lamp assembly comprising:
a reflector comprising first and second reflective concave surface regions adjacent to one another,
the first reflective concave surface region comprising a first curvature for directing light emanating from a first focal point adjacent to but spaced apart from the first reflective concave surface region into a near field beam, the first reflective concave surface region having a first peripheral edge with opposite ends and a first internal edge extending between the opposite ends of the first peripheral edge,
the second reflective concave surface region comprising a second curvature for directing light emanating from a second focal point adjacent to but spaced apart from the second reflective concave surface region into a far field beam, the second reflective concave surface region having a second peripheral edge with opposite ends and a second internal edge extending between the opposite ends of the second peripheral edge, the respective opposite ends of the first and second peripheral edges interfacing one another and the first and second internal edges interfacing one another;
a first light source positioned substantially at the first focal point, the first light source comprising a high intensity discharge light source;
a second light source positioned substantially at the second focal point, the second light source comprising a halogen light source; and
a light-transmissive cover fitted over the reflector.

10. A lamp assembly as recited in claim 9, wherein the first and second peripheral edges are arcuate.

11. A lamp assembly as recited in claim 9, wherein the first and second peripheral edges define a substantially circular outer perimeter of the reflector.

12. A lamp assembly as recited in claim 9, wherein the first and second reflective concave surface regions are integral with one another.

13. A lamp assembly as recited in claim 9, wherein the reflector is a unitary piece.

14. A lamp assembly as recited in claim 9, wherein the first and second internal edges interface and adjoin one another to define a ridge.

15. A lamp assembly as recited in claim 9, wherein the first concave reflective surface region is parabolic and has a first optical axis passing through the first focal point, and further wherein the second concave reflective surface region is parabolic and has a second optical axis passing through the second focal point.

16. A lamp assembly as recited in claim 9, wherein the second curvature differs from the first curvature.

17. A lamp assembly as recited in claim 9, wherein the high intensity discharge light source comprises a xenon light source.

18. A reflector comprising:
a first reflective concave surface region comprising a first curvature for directing light emanating from a first focal point adjacent to but spaced apart from the first reflective concave surface region into a near field beam, the first reflective concave surface region having a first arcuate peripheral edge with opposite ends and a first internal edge extending between the opposite ends of the first arcuate peripheral edge,
a second reflective concave surface region adjacent the first reflective concave surface region and comprising a second curvature for directing light emanating from a second focal point adjacent to but spaced apart from the second reflective concave surface region into a far field beam, the second reflective concave surface region having a second arcuate peripheral edge with opposite ends and a second internal edge extending between the opposite ends of the second arcuate peripheral edge, the respective opposite ends of the first and second peripheral edges interfacing one another to define a substantially circular outer perimeter of the reflector and the first and second internal edges interfacing one another.

19. A reflector as recited in claim 18, wherein the first and second reflective concave surface regions are integral with one another.

20. A reflector as recited in claim 18, wherein the reflector is a unitary piece.

21. A reflector as recited in claim 18, wherein the first concave reflective surface region is parabolic and has a first optical axis passing through the first focal point, and further wherein the second concave reflective surface region is parabolic and has a second optical axis passing through the second focal point.

22. A reflector as recited in claim 18, wherein the second curvature is different from the first curvature.
